(19) United States
(12) Patent Application Publication
(10) Pub. No.: US 2025/0173609 A1
(43) Pub. Date: May 29, 2025

(54) METHOD AND APPARATUS FOR LEARNING MULTI-TASK

(71) Applicants: HYUNDAI MOTOR COMPANY, Seoul (KR); Kia Corporation, Seoul (KR)

(72) Inventors: Jae Hyeon PARK, Hwaseong-si (KR); Jae Hoon CHO, Hwaseong-si (KR); Sam Yong KIM, Hwaseong-si (KR); Hyun Kook PARK, Hwaseong-si (KR)

(73) Assignees: HYUNDAI MOTOR COMPANY, Seoul (KR); Kia Corporation, Seoul (KR)

(21) Appl. No.: 18/810,438

(22) Filed: Aug. 20, 2024

(30) Foreign Application Priority Data
Nov. 27, 2023 (KR) 10-2023-0166997

(51) Int. Cl. G06N 20/00

(52) U.S. Cl. CPC G06N 20/00

(57) ABSTRACT

A multi-task learning method includes determining a relationship between a plurality of tasks, grouping the tasks into at least two groups based on the relationship between the tasks, configuring at least two neck networks respectively corresponding to the at least two groups, and learning a backbone network, the at least two neck networks, and a head network corresponding to each of the tasks based on a loss function for reflecting a negative transfer between head networks included in each group.

### CROSS-REFERENCE TO RELATED APPLICATION

The present application claims priority to Korean Patent Application No. 10-2023-0166997, filed on Nov. 27, 2023, the entire contents of which is incorporated herein for all purposes by this reference.

### BACKGROUND OF THE PRESENT DISCLOSURE

### Field of the Present Disclosure

The present disclosure relates to a multi-task learning technology, and relates to a multi-task learning method for learning multi-tasks based on task grouping, and an apparatus therefor.

### Description of Related Art

Multi-task learning is a technique that improves model performance by simultaneously learning a plurality of tasks through one model. The multi-task learning is known to show performance higher than single-task learning if the number of tasks is great and the number of data samples belonging to each task is small. The multi-task learning is mainly used to improve the model performance if the number of data samples belonging to a target task is small.

If the plurality of tasks are of opposite or different types, the multi-task learning technique may negatively affect the performance of the neural network, and may increase the time cost and computational cost of reaching the target performance. For example, a gradient collision in which opposing tasks including different gradient directions may occur frequently in a multi-task learning technique. Because the gradient collision cancels each other out if gradients colliding with each other are added to each other, learning may not be performed properly.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a multi-task learning method for learning multi-tasks based on task grouping, and an apparatus therefor.

Various aspects of the present disclosure are directed to providing a multi-task learning method for reducing a negative transfer between tasks, and an apparatus therefor.

Various aspects of the present disclosure are directed to providing a multi-task learning method for performing multi-tasks while the negative transfer between tasks is reduced by use of one backbone network and two or more neck networks, and an apparatus therefor.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a multi-task learning method includes calculating a relationship between a plurality of tasks, grouping the tasks into at least two groups based on the relationship between the tasks, configuring at least two neck networks respectively corresponding to the at least two groups, and learning a backbone network, the at least two neck networks, and a head network corresponding to each of the tasks based on a loss function for reflecting a negative transfer between head networks included in each group.

According to an exemplary embodiment of the present disclosure, the calculating may include calculating a loss of the respective head network taking an output of the backbone network as an input with respect to each of the tasks and calculating the relationship between the tasks based on a loss change of the respective head network.

According to an exemplary embodiment of the present disclosure, the calculating may include calculating the relationship between the tasks based on a loss change of each of remaining head networks before and after learning of the head network for the one task after a head network for one task among the tasks is learned to update the backbone network.

According to an exemplary embodiment of the present disclosure, the learning may include generating a feature covariance for a task of a respective head network included in the group, calculating a feature correlation corresponding to a difference from the feature covariance, and performing learning based on a negative transfer loss function for minimizing a feature corresponding to the feature correlation in the feature covariance.

According to an exemplary embodiment of the present disclosure, the learning may include generating a feature correlation matrix by assigning a value of ‘1’ to a difference, which is greater than or equal to a predetermined threshold value, among the difference from the feature covariance, and assigning a value of ‘0’ to a difference less than the threshold value and performing learning based on the negative transfer loss function for minimizing a feature corresponding to the value is ‘1’ based on the feature correlation matrix.

According to an exemplary embodiment of the present disclosure, the configuring may include configuring a neck network corresponding to the group by use of one or more networks with a hierarchical structure.

According to an aspect of the present disclosure, a multi-task learning apparatus includes a calculation device that calculates a relationship between a plurality of tasks, a grouping device that groups the tasks into at least two groups based on the relationship between the tasks, a configuration device that configures at least two neck networks respectively corresponding to the at least two groups, and a learning device that learns a backbone network, the at least two neck networks, and a head network corresponding to each of the tasks based on a loss function for reflecting a negative transfer between head networks included in each group.

According to an exemplary embodiment of the present disclosure, the calculation device may calculate a loss of the respective head network taking an output of the backbone network as an input with respect to each of the tasks, and may calculate the relationship between the tasks based on a loss change of the respective head network.

According to an exemplary embodiment of the present disclosure, the calculation device may calculate the relationship between the tasks based on a loss change of each of remaining head networks before and after learning of the head network for the one task after a head network for one task among the tasks is learned to update the backbone network.

According to an exemplary embodiment of the present disclosure, the learning device may be configured to generate a feature covariance for a task of a respective head network included in the group, may calculate a feature correlation corresponding to a difference from the feature covariance, and may perform learning based on a negative transfer loss function for minimizing a feature corresponding to the feature correlation in the feature covariance.

According to an exemplary embodiment of the present disclosure, the learning device may be configured to generate a feature correlation matrix by assigning a value of ‘1’ to a difference, which is greater than or equal to a predetermined threshold value, among the difference from the feature covariance, and assigning a value of ‘0’ to a difference less than the threshold value, and may perform learning based on the negative transfer loss function for minimizing a feature corresponding to the value is ‘1’ based on the feature correlation matrix.

According to an exemplary embodiment of the present disclosure, the configuration device may configure a neck network corresponding to the group by use of one or more networks with a hierarchical structure.

According to an aspect of the present disclosure, a multi-task apparatus includes a backbone network, at least two neck networks, each of which takes an output of the backbone network as an input, and each of which corresponds to a group determined based on a relationship between tasks, and a head network configured to take one output of outputs of the at least two neck networks as an input and to perform a corresponding task in response to each of the tasks.

According to an exemplary embodiment of the present disclosure, the respective head network may be learned based on a loss function that reflects a negative transfer between head networks included in a corresponding group among the group.

According to an exemplary embodiment of the present disclosure, the relationship between the tasks may be calculated based on a loss change of the respective head network after a loss of the respective head network taking the output of the backbone network as the input is calculated.

According to an exemplary embodiment of the present disclosure, the respective head network may be configured to generate a feature covariance for a task of a respective head network included in the group, may calculate a feature correlation corresponding to a difference from the feature covariance, and may perform learning based on a negative transfer loss function for minimizing a feature corresponding to the feature correlation in the feature covariance.

According to an exemplary embodiment of the present disclosure, the respective head network may be configured to generate a feature correlation matrix by assigning a value of ‘1’ to a difference, which is greater than or equal to a predetermined threshold value, among the difference from the feature covariance, and assigning a value of ‘0’ to a difference less than the threshold value, and may perform learning based on the negative transfer loss function for minimizing a feature corresponding to the value is ‘1’ based on the feature correlation matrix.

The features briefly summarized above with respect to the present disclosure are merely aspects of the detailed description of the present disclosure described below, and do not limit the scope of the present disclosure.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 shows a configuration of a multi-task apparatus, according to an exemplary embodiment of the present disclosure;

FIG. 2 shows an operation flowchart for a multi-task learning method according to another exemplary embodiment of the present disclosure;

FIG. 3 shows an example diagram for describing a multi-task learning method by use of an entire network;

FIG. 4 shows an example diagram for describing a process of calculating a task relationship;

FIG. 5 shows an example diagram for describing a process of configuring a multi-neck network based on task grouping;

FIG. 6A, FIG. 6B, FIG. 6C, and FIG. 6D show example diagrams for describing a process of learning a head network by use of a negative transfer loss function;

FIG. 7 shows an example diagram for describing a task execution result by a method, according to another exemplary embodiment of the present disclosure;

FIG. 8 shows a configuration of a multi-task learning apparatus, according to another exemplary embodiment of the present disclosure; and

FIG. 9 shows a block diagram of a computing system for executing a multi-task learning method, according to another exemplary embodiment of the present disclosure.

It may be understood that the appended drawings are not necessarily to scale, presenting a somewhat simplified representation of various features illustrative of the basic principles of the present disclosure. The predetermined design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various embodiments of the present disclosure will be described in detail with reference to the accompanying drawings, so that those skilled in the art may easily carry out the present disclosure. However, the present disclosure is not limited to the exemplary embodiments set forth herein and may be modified variously in many different forms.

In describing the exemplary embodiments of the present disclosure, if a specific description of related art is deemed to obscure the subject matter of the exemplary embodiments of the present disclosure, the detailed description will be omitted. Furthermore, in the drawings, parts that are not related to the description of the present disclosure are omitted, and similar parts are provided similar reference numerals.

In an exemplary embodiment of the present disclosure, it will be understood that if an element is referred to as being “connected” or “coupled” to another element, it may be directly connected or indirectly connected to another element. Furthermore, if some part ‘includes’ or “possess” some elements, unless explicitly described to the contrary, it means that other elements may be further included but not excluded.

In an exemplary embodiment of the present disclosure, expressions such as “first,” or “second,” and the like, may express their elements regardless of their priority or importance and may be used to distinguish one element from another element but is not limited to these components. Therefore, without departing from the scope of the present disclosure, a first component of various exemplary embodiments of the present disclosure may be referred to as a second component of another exemplary embodiment of the present disclosure. Similarly, a second component of various exemplary embodiments of the present disclosure may be referred to as a first component of another exemplary embodiment of the present disclosure.

In an exemplary embodiment of the present disclosure, components that are distinguished from each other are only for clearly describing characteristics, and do not mean that the components are necessarily separated. That is, a plurality of components may be integrated to form a single hardware or software unit, or a single component may be distributed to form a plurality of hardware or software units. Accordingly, such integrated or distributed embodiments are included in the scope of the present disclosure, even though not mentioned separately.

In an exemplary embodiment of the present disclosure, components described In various embodiments do not necessarily mean essential components, and some may be optional components. Therefore, an exemplary embodiment composed of a subset of components described in an exemplary embodiment of the present disclosure is also included in the scope of the present disclosure. Furthermore, various exemplary embodiments including other components in addition to the components described in various exemplary embodiments of the present disclosure are also included in the scope of the present disclosure.

In an exemplary embodiment of the present disclosure, expressions of positional relationships used herein, such as upper, lower, left, and right, are described for convenience of description. If viewing the drawings shown in the present specification in reverse, the positional relationship described in the specification may be interpreted in the opposite manner.

In an exemplary embodiment of the present disclosure, the expressions “A or B”, “at least one of A and B”, “at least one of A or B”, “A, B, or C”, “at least one of A, B, and C”, and “at least one of A, B, or C” may include any and all combinations of one or more of the associated listed items.

Various image recognition networks including 2D/3D object detection, semantic segmentation, and depth estimation are applied to autonomous driving vehicles. Because each network receives the same image input, but operates with a separate backbone network, each network includes a form of repeatedly performing similar operations.

Multi-task learning may be a learning paradigm that seeks to improve the overall performance of all tasks by simultaneously learning tasks associated with each other. Performance improvement and repetitive calculations may be explicitly avoided if a memory is reduced due to layer sharing, and related tasks share complementary information, and thus the multi-task learning may include improved inference speed for all tasks.

On the other hand, the multi-task learning leads to a decrease in the performance of tasks due to the difficulty of building a dataset and the negative transfer that adversely affects other tasks during learning.

This multi-task learning is performed through hard parameter sharing or soft parameter sharing.

The hard parameter sharing refers to a method mainly used if multi-task pixel-level prediction is performed. The hard parameter sharing divides a task output and designs a unique decoder for each task, which is advantageous in terms of a hardware resource, but causes negative transfer issues, resulting in significant performance degradation.

The soft parameter sharing shares parameters with a backbone network and improves performance compared to the hard parameter sharing. However, the soft parameter sharing may be computationally more expensive than hard parameters and may lead to overfitting.

The multi-task learning refers to a method of simultaneously learning multiple tasks by use of a plurality of output layers in one deep learning network. Nowadays, in autonomous driving technologies, to simultaneously process a plurality of artificial intelligence models in real time on the limited hardware resources of autonomous vehicles, multi-task learning techniques that learn multiple tasks by use of a single backbone network are being provided.

However, a simple multi-task model that simply designs tasks as outputs of the head network part does not consider the relationship between tasks, resulting in a performance degradation of tasks, which is called a negative transfer.

In an exemplary embodiment of the present disclosure, multi-task performance is improved while a negative transfer between tasks is reduced, by configuring at least two neck networks corresponding to two or more groups after tasks are grouped into at least two groups based on relationships between tasks, and learning multi-tasks based on a loss function (hereinafter referred to as a “negative transfer loss function”) for minimizing the negative transfer between tasks in each group.

The task in the technology of the present disclosure refers to an issue to be solved through machine learning or a task to be performed through machine learning. For example, if face recognition, expression recognition, gender classification, pose classification, or the like is performed from face data, the face recognition, the expression recognition, the gender classification, the pose classification or the like may correspond to individual tasks, respectively. If object detection, depth estimation, and semantic segmentation for recognizing objects such as vehicles, pedestrians, and signs from image data obtained in real time by a camera of an autonomous vehicle are performed, the object detection, the depth estimation, and the semantic segmentation may correspond to individual tasks.

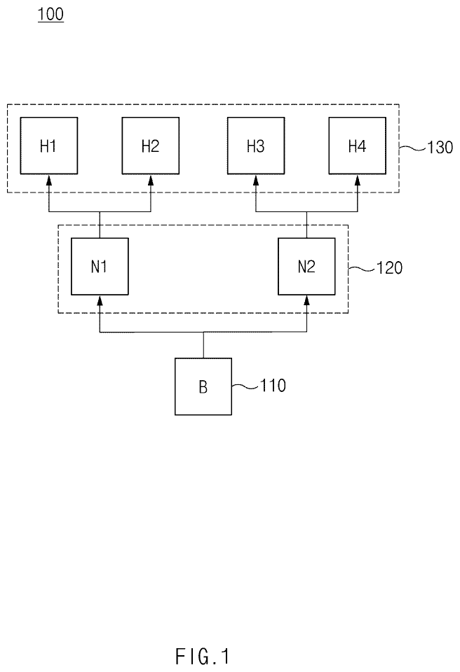

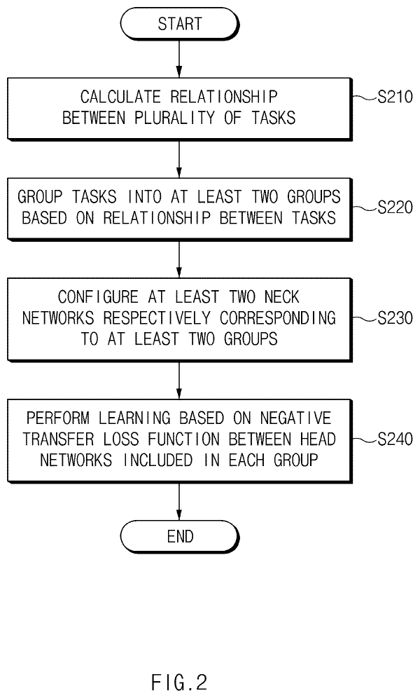

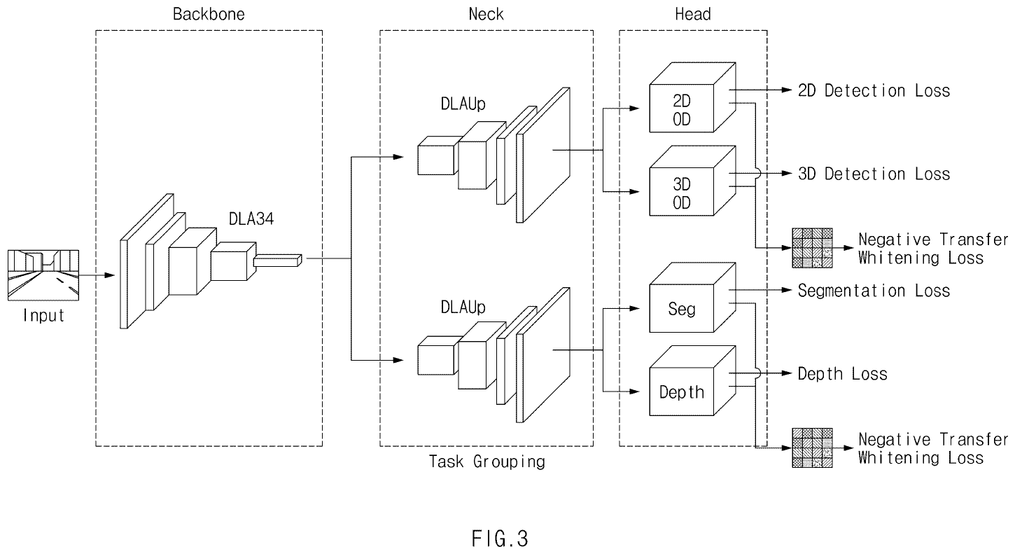

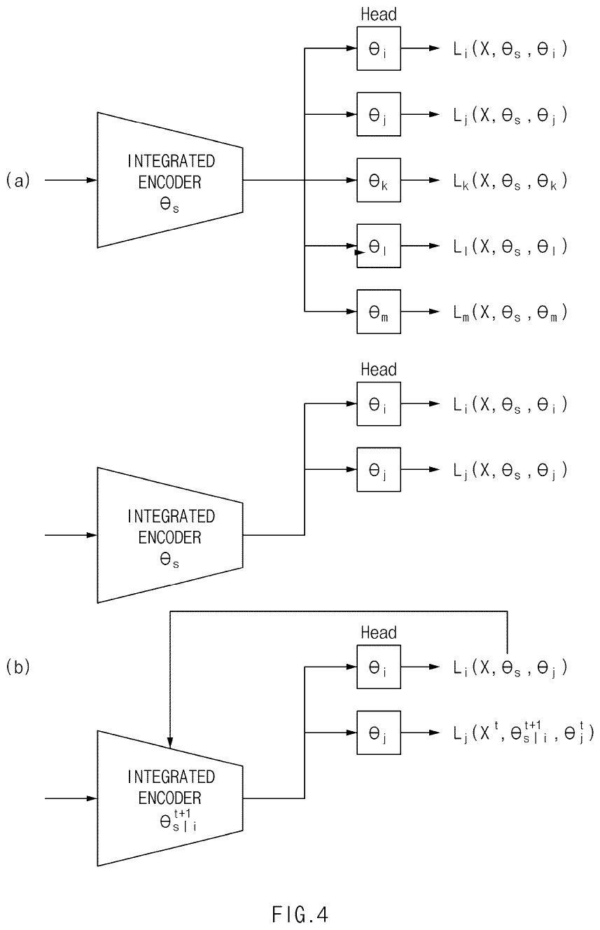

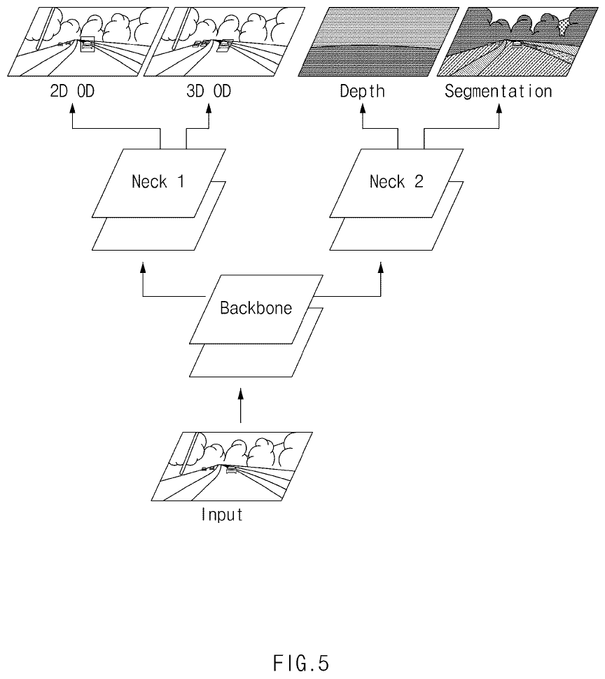

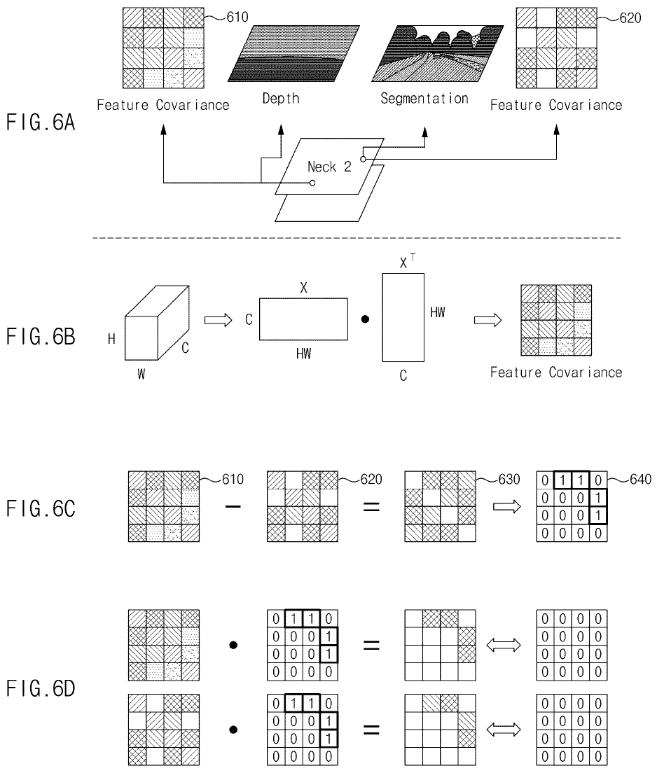

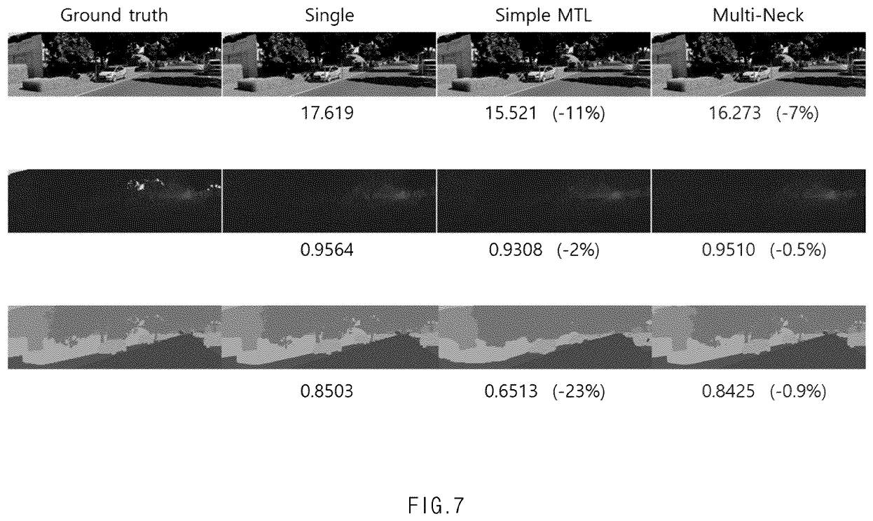

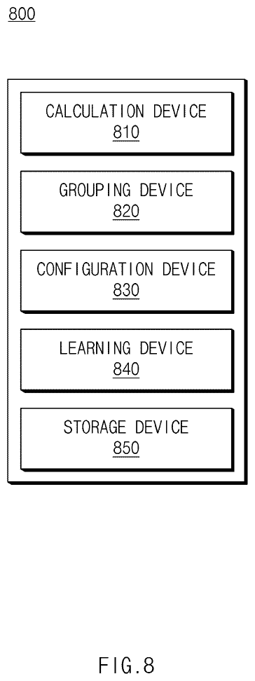

A multi-task learning method, an apparatus therefor, and a multi-task apparatus according to various exemplary embodiments of the present disclosure will be described with reference to FIG. 1, FIG. 2, FIG. 3, FIG. 4, FIG. 5, FIG. 6, FIG. 7, and FIG. 8.

FIG. 1 shows a configuration of a multi-task apparatus, according to an exemplary embodiment of the present disclosure.

Referring to FIG. 1, a multi-task apparatus 100 according to an exemplary embodiment of the present disclosure includes one backbone network 110, at least two neck networks 120, and a head network 130 corresponding to each of tasks.

The backbone network 110 is a shared network, and extracts common features for input images and provides common features. The backbone network 110 refers to a basic network for multi-task learning, and thus detailed descriptions thereof will be omitted to avoid redundancy.

In the instant case, the backbone network 110 may provide a common feature map for the input image to the neck network, and may provide the neck network with various levels of feature maps for each layer or stage.

Each of the at least two neck networks 120 refers to a network that connects the head network 130 and the backbone network 110 corresponding to a task grouped into groups based on a task relationship, and extracts different feature maps from different stages of the backbone network 110 and provides the different feature maps to the head network 130.

In the instant case, each of neck networks 120 may be configured based on the task relationship. For example, a first neck network N1 may be configured based on a relationship between task 1 (e.g., 2D object detection) and task 2 (e.g., 3D object detection). A second neck network N2 may be configured based on a relationship between task 3 (e.g., semantic segmentation) and task 4 (e.g., depth estimation).

According to an exemplary embodiment of the present disclosure, each of the neck networks 120 may include one or more networks with a hierarchical structure. Moreover, even though the neck network includes one or more networks with a hierarchical structure, the relationship between tasks may be reflected.

Each of the neck networks 120 may include a feature pyramid network (FPN), a path aggregation network (PANet), Bi-FPN, or the like. The stage forming each neck network may be determined by an individual or business operator providing the technology according to an exemplary embodiment of the present disclosure.

This neck network is also apparent to those skilled in the art in multi-task learning, and thus detailed descriptions thereof will be omitted to avoid redundancy.

On the other hand, a feature of the multi-task apparatus according to an exemplary embodiment of the present disclosure means that the neck network 120, which takes the output of the backbone network 110 as an input, is formed to correspond to each of the grouped groups based on a task relationship rather than a single task.

Here, the task relationship may be calculated based on a change in the loss of each of the head networks 130 by calculating the loss of each of the head networks 130 taking the output of the backbone network 110 as an input. Accordingly, detailed descriptions thereof will be described later.

Each of the head networks 130 refers to a network for performing a predetermined task, and performs a task (e.g., 2D object detection, 3D object detection, semantic segmentation, depth estimation, and the like) on an input image by use of the output of the neck network 120 of the corresponding group as an input.

According to an exemplary embodiment of the present disclosure, each of the head networks 130 may be learned based on a negative transfer loss function that reflects a negative transfer between head networks included in the corresponding group among groups determined based on the task relationship.

According to an exemplary embodiment of the present disclosure, each of the head networks 130 may generate a feature covariance for a task of each of the head networks included in a group, may calculate a feature correlation corresponding to a difference between feature covariances, and may perform learning based on a negative transfer loss function for minimizing the feature corresponding to feature correlation in the feature covariance.

Here, each of the head networks 130 may generate a feature correlation matrix by assigning a value of ‘1’ to a difference, which is greater than or equal to a predetermined threshold value, among the difference between feature covariances, and assigning a value of ‘0’ to the difference less than the threshold value, and may perform learning based on a negative transfer loss function for minimizing a feature corresponding to the value is ‘1’, based on the feature correlation matrix.

According to an exemplary embodiment of the present disclosure, the backbone network 110 and the neck network 120 may also be learned together with the head network 130, which may also be learned based on the negative transfer loss function.

According to an exemplary embodiment of the present disclosure, the backbone network 110 may be learned in advance if extracting a common feature for each task, and may also be learned by use of the negative transfer loss function together with the neck network 120 and the head network 130. Furthermore, in addition to the exemplary embodiment of the present disclosure, the backbone network and the neck network may also be learned separately.

The method and apparatus for learning the multi-task apparatus are described as follows.

FIG. 2 shows an operation flowchart for a multi-task learning method according to another exemplary embodiment of the present disclosure, and shows an operation flowchart for a method for learning the multi-task apparatus of FIG. 1.

Referring to FIG. 2, a multi-task learning method according to another exemplary embodiment of the present disclosure calculates a relationship (task relationship) between a plurality of tasks (e.g., tasks to be performed in an autonomous vehicle) for performing multiple tasks, and groups the tasks into at least two groups based on the calculated task relationship (S210, S220).

According to an exemplary embodiment of the present disclosure, S210 may include calculating a loss of each head network corresponding to each task, which utilizes an output of the backbone network or a predetermined integrated network as an input with respect to each task, and calculating the task relationship based on a change in loss of each head network.

For example, S210 may include calculating the relationship between one task and the remaining tasks based on a loss change of each of the remaining head networks before and after learning the head network for the one task after the head network for one of the tasks is learned to update the backbone network or integrated network.

According to an exemplary embodiment of the present disclosure, S220 may include grouping one task and the corresponding task as one group by determining that the task of the corresponding head network is associated with one task, if the loss change is greater than the reference value (e.g., if the reference value is ‘0’ and the loss change includes a positive value) by comparing the loss change with the predetermined reference value for each head network. Furthermore, the reference value may be determined by the business operator or individual providing the technology of the present disclosure, and may be variously determined by grouping tasks into groups based on the task relationship.

If the tasks are grouped into at least two groups in S220, the multi-task learning method configures at least two neck networks respectively corresponding to at least two groups, and learns a head network of the corresponding group, a neck network and the head network of the corresponding group, or a backbone network, the neck network of the corresponding group, and the head network of the corresponding group based on a negative transfer loss function between head networks included in each group (S230, S240).

According to an exemplary embodiment of the present disclosure, S240 may learn a network based on the loss function of the head network if there is only one head network included in the neck network.

According to an exemplary embodiment of the present disclosure, S240 may generate a feature covariance for each task of the head network included in a group, may calculate a feature correlation corresponding to the difference between feature covariances, and may learn a network based on a negative transfer loss function for minimizing a feature corresponding to the feature correlation in the feature covariance. For example, S240 may generate a feature correlation matrix by assigning a value of ‘1’ to a difference, which is greater than or equal to a predetermined threshold value (e.g., setting a threshold value to 0.3), among the difference between feature covariances, and assigning a value of ‘0’ to the difference less than the threshold value, and may learn a network based on a negative transfer loss function for minimizing a feature corresponding to the value is ‘1’, based on the feature correlation matrix.

FIG. 3 shows an example diagram for describing a multi-task learning method by use of an entire network. As shown in FIG. 3, the entire network includes a backbone network (Backbone) that receives an input image and outputs a common feature map of an input image for tasks, at least two neck networks (Neck) configured by task grouping (Task Grouping), and a plurality of head networks (Head) connected to each neck network.

The backbone network may be configured by Deep Layer Aggregation 34 (DLA34). The DLA is a network known to those skilled in the art, and thus detailed descriptions thereof will be omitted to avoid redundancy. Here, 34 may mean including 34 convolutional layers. Furthermore, the backbone network may include various networks as well as DLA34.

Each of the neck networks may be configured based on DLAUp. Furthermore, the neck networks may be configured based on FPN, PANet, Bi-FPN, or the like.

The head network connected to each task-grouped neck network may be a network grouped by a task relationship, and may be learned based on a loss function for the corresponding task and the negative transfer loss function between tasks included in the corresponding group.

For example, a head network performing a task of 2D object detection (2D OD) and a head network performing a task of 3D object detection (3D OD) are connected to one neck network to perform the corresponding task by use of the output of the neck network as an input. In the instant case, each of the 2D OD head network and the 3D OD head network may be learned based on the loss function (2D Detection Loss and 3D Detection Loss) for performing the corresponding task and the negative transfer loss function (Negative Transfer Whitening Loss) that reflects a negative transfer between two tasks.

For example, a head network performing a semantic segmentation task and a head network performing a depth estimation task are connected to one neck network to perform the corresponding task by use of the output of the neck network as an input. In the instant case, each of the seg head network and the depth head network may be learned based on the loss function (Segmentation Loss and Depth Loss) for performing the corresponding task and the negative transfer loss function (Negative Transfer Whitening Loss) that reflects a negative transfer between two tasks.

FIG. 4 shows an example diagram for describing a process of calculating a task relationship.

As shown in FIG. 4, a method according to the exemplary embodiment of the present disclosure may calculate a loss for each task through gradient update to calculate a task relationship, and may identify increase/decrease information of the loss to identify the relationship between tasks.

The multi-task loss function for the head networks shown in FIG. 4 may be expressed as Equation 1 below.

$${L}_{total} ( χ , {θ}_{s} , \{ {θ}_{i} \} ) = {\sum }_{i ∈ τ} {L}_{i} ( χ , {θ}_{s} , {θ}_{i} ) \qquad [ Equation 1 ]$$

Here, θₛ may denote shared parameters of an integrated encoder; θᵢ may denote specific parameters of a head network corresponding to task i; χ may denote a training batch; and Lᵢ may denote a loss function of task i.

The integrated encoder may be learned according to Equation 2 below, and may be learned based on stochastic gradient descent.

$${θ}_{s \vert i}^{t + 1} : = {θ}_{s}^{t} - η {∇}_{{θ}_{s}^{t}} {L}_{i} ( {χ}^{t} , {θ}_{s}^{t} , {θ}_{i}^{t} ) \qquad [ Equation 2 ]$$

Here, θ_{s|i}^{t+1} may denote shared parameters updated after a gradient step for task i; θₛ^{t} may denote shared parameters after time step t before update; θᵢ^{t} may denote specific parameters of a head network corresponding to task i after time step t for task I; η may denote a step size; and χ^{t} may denote a training batch.

The relationship of task j to task i at step t may be calculated according to Equation 3 below.

$${i \to t}_{t}^{} = 1 - \frac{{L}_{j} ( {χ}^{t} , {θ}_{s \vert i}^{t + 1} , {θ}_{j}^{t} )}{{L}_{j} ( {χ}^{t} , {θ}_{s}^{t} , {θ}_{j}^{t} )} \qquad [ Equation 3 ]$$

Here, Lⱼ(χ^{t}, θₛ^{t}, θⱼ^{t}) may denote a loss of task j for an integrated encoder before the update; Lⱼ(χ^{t}, θ_{s|i}^{t+1}, θⱼ^{t}) may denote a loss of the updated task j for the integrated encoder updated with a step of task i; and θⱼ^{t} may denote specific parameters of a head network corresponding to task j after time step t for task j.

For example, if a loss value of task j is 0.3, and a loss value of task j is reduced to 0.2 after task i is learned to update the integrated network, the relationship between task i and task j may be learned by calculating the degree of change in the loss value of task j according to Equation 3. Here, Z=1−0.2/0.3=1/3.

The case that value Z in Equation 3 is a positive value may mean that the parameter value for task j is less than an original parameter value due to the update to a parameter. The case that value Z is a negative value may mean that a shared parameter update is negative for the performance of task j.

The above-described process may calculate a relationship between final tasks by calculating the average across all steps or successive subsets of a step.

FIG. 5 shows an example diagram for describing a process of configuring a multi-neck network based on task grouping.

As shown in FIG. 5, a method according to an exemplary embodiment of the present disclosure may design a multi-neck network structure based on a task relationship calculated through the above-described process. In the case of FIG. 5, a multi-neck network structure of two neck networks Neck1 and Neck2 may be configured by grouping 2D object detection (2D OD) task and 3D object detection (3D OD) task into one group according to the task relationship, and grouping the semantic segmentation (Segmentation) task and depth estimation (Depth) task into another group.

The backbone network may extract common features for a scene (input) from labels of various tasks while all tasks are shared, and may reduce inference time.

Each neck network may share tasks with a high relationship by reflecting the task grouping result (i.e., a task relationship calculating result), and tasks with low relationship may be shared through another neck network.

Each task may include a separate head network, and each head network may include a task feature structure.

FIG. 6A, FIG. 6B, FIG. 6C, and FIG. 6D show example diagrams for describing a process of learning a head network by use of a negative transfer loss function, and show example diagrams for describing a process of learning a depth estimation task and a semantic segmentation task.

As shown in FIG. 6A, FIG. 6B, FIG. 6C, and FIG. 6D, a method according to an exemplary embodiment of the present disclosure may use a negative transfer loss function between a depth estimation task and a semantic segmentation task for reducing a negative transfer influence between tasks grouped if task-grouped depth estimation task (Depth) and semantic segmentation task (Segmentation) are learned (FIG. 6A).

To describe a learning process by use of a negative transfer loss function between a depth estimation task and a semantic segmentation task, the method reshapes and transposes output features (H, W, C) of each of the grouped tasks to generate feature covariances 610 and 620 configured for expressing self-correlation (FIG. 6B).

If the feature covariances 610 and 620 are generated from each of the depth estimation task and semantic segmentation task, the method calculates a difference 630 between the feature covariances 610 and 620, and generates a feature correlation matrix 640 based on the difference 630 between the feature covariances 610 and 620 (FIG. 6C).

In the instant case, the feature correlation matrix 640 may be generated by assigning a value of ‘1’ to the difference (e.g., 0.3) greater than or equal to the predetermined threshold value, and assigning a value of ‘0’ to the difference less than the threshold value among the difference 630 between the feature covariances 610 and 620.

The fact that the difference 630 between the feature covariances 610 and 620 is small may mean that there are many common components extracted from the depth estimation task and the semantic segmentation task. The fact that the difference 630 between the feature covariances 610 and 620 is great may mean that a negative transfer occurs because characteristics of the depth estimation task and the semantic segmentation task are very different from each other.

If the feature correlation matrix 640 is generated through the above-described process, the method performs element-wise multiplication between the feature correlation matrix 640 and the feature covariances 610 and 620 extracted from the depth estimation task and semantic segmentation task, and then performs calculations on a negative transfer loss function so that features capable of causing the negative transfer are small or minimized (FIG. 6D).

FIG. 7 shows an example diagram for describing a task execution result by a method, according to another exemplary embodiment of the present disclosure.

The task relationship calculation result indicating that the similarity between a 2D object detection task and a 3D object detection task is high, and the similarity between a semantic segmentation task and depth estimation task is high, is determined by a method according to another exemplary embodiment of the present disclosure. In the present way, a neck network from grouping the 2D object detection task and 3D object detection task and a neck network from grouping the semantic segmentation task and depth estimation task are configured, and the inference time is reduced by 48% from 32.6 [ms] to 17.1 [ms] by learning the neck network by use of the negative transfer loss function for each group. As shown in FIG. 7, it may be seen that the accuracy is close to that of a single task, and the negative transfer is minimized compared to the conventional Multi-Head structure (Simple MTL).

Accordingly, a multi-task apparatus and a multi-task learning method according to an exemplary embodiment of the present disclosure may perform multi-tasks while reducing a negative transfer between tasks, by learning multi-tasks based on task grouping by use of one backbone network and two or more neck networks.

Moreover, a multi-task apparatus and a multi-task learning method according to an exemplary embodiment of the present disclosure may expect a significant reduction in computation volume and may reduce costs, by use of only one backbone network.

Furthermore, a multi-task apparatus and a multi-task learning method according to an exemplary embodiment of the present disclosure may share a multi-scale feature map between similar tasks through a multi-neck structure to prevent overfitting and to extract a generalized feature map.

Besides, a multi-task apparatus and a multi-task learning method according to an exemplary embodiment of the present disclosure may expect the scalability of a task by adding only a head network of the task to a neck network of a similar group through a task relationship without the need to add a backbone network even though a new image recognition task is added.

FIG. 8 shows a configuration of a multi-task learning apparatus, according to another exemplary embodiment of the present disclosure, and shows a configuration of a device performing the method of FIG. 2, FIG. 3, FIG. 4, FIG. 5, FIG. 6, and FIG. 7.

Referring to FIG. 8, a multi-task learning apparatus 800 according to another exemplary embodiment of the present disclosure includes a calculation device 810, a grouping device 820, a configuration device 830, a learning device 840, and a storage device 850.

The storage device 850 may be a means of storing all data related to the technology of the present disclosure, and may store an input image, a learning model for each network, an algorithms or mathematical equation for calculating a task relationship, and a method for performing learning based on the negative transfer loss function. In addition, the storage device 850 may also store all types of data and algorithms associated with the technology of the present disclosure.

The calculation device 810 calculates a relationship between a plurality of tasks (e.g., tasks to be performed in an autonomous vehicle) for performing multi-tasks.

According to an exemplary embodiment of the present disclosure, the calculation device 810 may calculate a loss of each head network corresponding to each task, which utilizes an output of the backbone network or a predetermined integrated network as an input with respect to each task, and may calculate the task relationship based on a change in loss of each head network.

According to an exemplary embodiment of the present disclosure, the calculation device 810 may calculate the relationship between one task and the remaining tasks based on a loss change of each of the remaining head networks before and after learning the head network for the one task after the head network for one of the tasks is learned to update the backbone network or integrated network.

The grouping device 820 groups tasks into at least two groups based on the task relationship calculated by the calculation device 810.

According to an exemplary embodiment of the present disclosure, the grouping device 820 may group one task and the corresponding task as one group by determining that the task of the corresponding head network is associated with one task, if the loss change is greater than the reference value (e.g., if the reference value is ‘0’ and the loss change includes a positive value) by comparing the loss change with the predetermined reference value for each head network.

The configuration device 830 configures at least two neck networks corresponding to at least two groups grouped by the grouping device 820.

The learning device 840 learns a head network of the corresponding group, a neck network and the head network of the corresponding group, or a backbone network, the neck network of the corresponding group, and the head network of the corresponding group based on a negative transfer loss function between head networks included in each group.

According to an exemplary embodiment of the present disclosure, the learning device 840 may learn a network based on the loss function of the head network if there is only one head network included in the neck network.

According to an exemplary embodiment of the present disclosure, the learning device 840 may be configured to generate a feature covariance for a task of each of the head networks included in a group, may calculate a feature correlation corresponding to a difference between feature covariances, and may learn a network based on a negative transfer loss function for minimizing the feature corresponding to feature correlation in the feature covariance. For example, the learning device 840 may be configured to generate a feature correlation matrix by assigning a value of ‘1’ to a difference, which is greater than or equal to a predetermined threshold value, among the difference between feature covariances, and assigning a value of ‘0’ to the difference less than the threshold value, and may learn a network based on a negative transfer loss function for minimizing a feature corresponding to the value is ‘1’, based on the feature correlation matrix.

Even though the description is omitted in the apparatus according to another exemplary embodiment of the present disclosure, it will be apparent to those skilled in the art that the apparatus according to another exemplary embodiment of the present disclosure may include all of the contents described in the method of FIG. 2, FIG. 3, FIG. 4, FIG. 5, FIG. 6, FIG. 7, and FIG. 8, and this will be obvious to those skilled in the art.

In an exemplary embodiment of the present disclosure, each of the calculation device 810, the grouping device 820, the configuration device 830 and the learning device 840 may be implemented by a processor in a form of hardware or software, or in a combination of hardware and software. Alternatively, the calculation device 810, the grouping device 820, the configuration device 830 and the learning device 840 may be implemented as a single processor in a form of hardware or software, or in a combination of hardware and software.

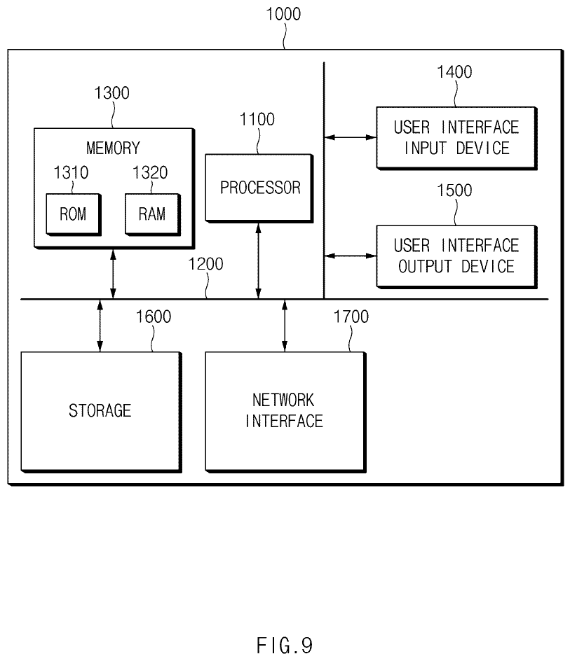

FIG. 9 shows a block diagram of a computing system for executing a multi-task learning method, according to another exemplary embodiment of the present disclosure.

Referring to FIG. 9, a computing system 1000 may include at least one processor 1100, a memory 1300, a user interface input device 1400, a user interface output device 1500, storage 1600, and a network interface 1700, which are connected to each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a Read-Only Memory (ROM) 1310 and a Random Access Memory (RAM) 1320.

Accordingly, the processes of the method or algorithm described in relation to the exemplary embodiments of the present disclosure may be implemented directly by hardware executed by the processor 1100, a software module, or a combination thereof. The software module may reside in a storage medium (that is, the memory 1300 and/or the storage 1600), such as a RAM, a flash memory, a ROM, an EPROM, an EEPROM, a register, a hard disk, solid state drive (SSD), a detachable disk, or a CD-ROM. The exemplary storage medium is coupled to the processor 1100, and the processor 1100 may read information from the storage medium and may write information in the storage medium. In another method, the storage medium may be integrated with the processor 1100. The processor 1100 and the storage medium may reside in an application specific integrated circuit (ASIC). The ASIC may reside in a user terminal. In another method, the processor 1100 and the storage medium may reside in the user terminal as an individual component.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

Therefore, the exemplary embodiments of the present disclosure are provided to explain the spirit and scope of the present disclosure, but not to limit them, so that the spirit and scope of the present disclosure is not limited by the embodiments. The scope of the present disclosure should be construed based on the accompanying claims, and all the technical ideas within the scope equivalent to the claims should be included in the scope of the present disclosure.

According to an exemplary embodiment of the present disclosure, multi-tasks may be performed while a negative transfer between tasks is reduced, by learning multi-tasks based on task grouping by use of one backbone network and two or more neck networks.

According to an exemplary embodiment of the present disclosure, a significant reduction in computation volume may be expected and costs may be reduced, by use of only one backbone network.

According to an exemplary embodiment of the present disclosure, a multi-scale feature map may be shared between similar tasks through a multi-neck structure to prevent overfitting and to extract a generalized feature map.

According to an exemplary embodiment of the present disclosure, the scalability of a task may be expected by adding only a head network of the task to a neck network of a similar group through a task relationship without the need to add a backbone network even though a new image recognition task is added.

Effects obtained in an exemplary embodiment of the present disclosure are not limited to the above-mentioned effects, and other effects that are not mentioned will be clearly understood by those skilled in the art, to which the present disclosure belongs, from the following description.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A multi-task learning method, the method comprising:
determining a relationship between a plurality of tasks;
grouping the tasks into at least two groups based on the relationship between the tasks;
configuring at least two neck networks respectively corresponding to the at least two groups; and
learning a backbone network, the at least two neck networks, and a head network corresponding to each of the tasks based on a loss function for reflecting a negative transfer between head networks included in each group.

2. The method of claim 1, wherein the determining of the relationship between the plurality of tasks includes:
determining a loss of the respective head network taking an output of the backbone network as an input with respect to each of the tasks; and
determining the relationship between the tasks based on a loss change of the respective head network.

3. The method of claim 2, wherein the determining of the relationship between the plurality of tasks further includes:
after a head network for one task among the tasks is learned to update the backbone network, determining the relationship between the tasks based on a loss change of each of remaining head networks before and after the learning of the head network for the one task.

4. The method of claim 1, wherein the learning includes:
generating a feature covariance for a task of the respective head network included in each group;
determining a feature correlation corresponding to a difference from the feature covariance; and
performing the learning based on a negative transfer loss function for minimizing a feature corresponding to the feature correlation in the feature covariance.

5. The method of claim 4, wherein the learning further includes:
generating a feature correlation matrix by assigning a value of ‘1’ to a difference, which is greater than or equal to a predetermined threshold value, among the difference from the feature covariance, and assigning a value of ‘0’ to a difference less than the threshold value; and
performing learning based on the negative transfer loss function for minimizing a feature corresponding to the value is ‘1’ based on the feature correlation matrix.

6. The method of claim 1, wherein the configuring includes:
configuring a neck network corresponding to each group by use of one or more networks with a hierarchical structure.

7. A multi-task learning apparatus comprising:
a calculation device configured to determine a relationship between a plurality of tasks;
a grouping device configured to group the tasks into at least two groups based on the relationship between the tasks;
a configuration device configured to configure at least two neck networks respectively corresponding to the at least two groups; and
a learning device configured to learn a backbone network, the at least two neck networks, and a head network corresponding to each of the tasks based on a loss function for reflecting a negative transfer between head networks included in each group.

8. The multi-task learning apparatus of claim 7, wherein the calculation device is further configured to:
determine a loss of the respective head network taking an output of the backbone network as an input with respect to each of the tasks; and
determine the relationship between the tasks based on a loss change of the respective head network.

9. The multi-task learning apparatus of claim 8, wherein the calculation device is further configured to:
after a head network for one task among the tasks is learned to update the backbone network, determine the relationship between the tasks based on a loss change of each of remaining head networks before and after the learning of the head network for the one task.

10. The multi-task learning apparatus of claim 7, wherein the learning device is further configured to:
generate a feature covariance for a task of the respective head network included in each group;
determine a feature correlation corresponding to a difference from the feature covariance; and
perform learning based on a negative transfer loss function for minimizing a feature corresponding to the feature correlation in the feature covariance.

11. The multi-task learning apparatus of claim 10, wherein the learning device is further configured to:
generate a feature correlation matrix by assigning a value of ‘1’ to a difference, which is greater than or equal to a predetermined threshold value, among the difference from the feature covariance, and assigning a value of ‘0’ to a difference less than the threshold value; and
perform the learning based on the negative transfer loss function for minimizing a feature corresponding to the value is ‘1’ based on the feature correlation matrix.

12. The multi-task learning apparatus of claim 7, wherein the configuration device is further configured to:
configure a neck network corresponding to each group by use of one or more networks with a hierarchical structure.

13. A multi-task apparatus comprising:
a backbone network;
at least two neck networks, each of which takes an output of the backbone network as an input, and each of which corresponds to a group determined based on a relationship between tasks; and
a head network configured to take one output of outputs of the at least two neck networks as an input and to perform a corresponding task in response to each of the tasks.

14. The multi-task apparatus of claim 13, wherein the respective head network is learned based on a loss function that reflects a negative transfer between head networks included in a corresponding group among the group.

15. The multi-task apparatus of claim 13, wherein the relationship between the tasks is determined based on a loss change of the respective head network after a loss of the respective head network taking the output of the backbone network as the input is calculated.

16. The multi-task apparatus of claim 13, wherein the respective head network is configured to:
generate a feature covariance for a task of a respective head network included in the group;
determine a feature correlation corresponding to a difference from the feature covariance; and
perform learning based on a negative transfer loss function for minimizing a feature corresponding to the feature correlation in the feature covariance.

17. The multi-task apparatus of claim 16, wherein the respective head network is configured to:
generate a feature correlation matrix by assigning a value of ‘1’ to a difference, which is greater than or equal to a predetermined threshold value, among the difference from the feature covariance, and assigning a value of ‘0’ to a difference less than the threshold value; and
perform learning based on the negative transfer loss function for minimizing a feature corresponding to the value is ‘1’ based on the feature correlation matrix.
